(19) United States
(12) Patent Application Publication
(10) Pub. No.: US 2021/0171793 A1
(43) Pub. Date: Jun. 10, 2021

(54) FLUOROPOLYMER-BASED POWDER COATING

(71) Applicant: Arkema Inc., King of Prussia, PA (US)

(72) Inventors: David A. SEILER, Garnet Valley, PA (US); James T. GOLDBACH, Paoli, PA (US); George FISHER, Centerville, UT (US)

(21) Appl. No.: 17/052,285

(22) PCT Filed: May 7, 2019
(86) PCT No.: PCT/US2019/030993

§ 371 Date: Nov. 2, 2020

Related U.S. Application Data
(60) Provisional application No. 62/673,308, filed on May 18, 2018.

(51) Int. Cl. C09D 127/16

(52) U.S. Cl. CPC C09D 127/16

(57) ABSTRACT

A fluoropolymer-based powdered composition is disclosed. The fluoropolymer has a very low melt viscosity, of less than 2 kilopoise (kP) at 230° C. and 100 s⁻¹ and molecular weights of from 15 kDa to 200 kDa. The composition can be used for powder coating or rotolining processes. The coatings or interior surfaces of the coated or rotolined parts exhibit roughness values, Ra, of less than 25 μin (0.64 μm) corresponding to very smooth surfaces. The coating exhibit very good adhesion to substrates with and without surface preparation as well as very good adhesion to substrates with and without primer.

### FIELD OF THE INVENTION

The invention relates to a fluoropolymer-based powder coating. The fluoropolymer compositions have a viscosity less than 2.0 kilopoise (kP) at 230° C. and 100 s⁻¹ shear rate as exemplified in ASTM D1238-13. The powder coatings can be applied to bare or primed substrates. The fluoropolymer powder coatings made using these materials have a very low surface roughness while retaining good impact strength and bending ductility despite their lower viscosity. The fluoropolymer powder coatings exhibit excellent adhesion to substrates both with and without primer.

### BACKGROUND OF THE INVENTION

Fluoropolymers, especially those based on polyvinylidene fluoride (PVDF) have long been used in chemical and radiation resistant powder coating applications because of their long life performance in these rigorous environments. However, certain applications, for instance nuclear glove boxes and coatings in the biopharma area require extremely smooth surfaces, <10 min measured according to ASME B46.1-2009 that are difficult to achieve with currently available PVDF based polymers. These applications also require good impact strength as described in ASTM D2794-93(2010) as well as good bending ductility as described in ASTM D3451-06(2017) (Standard Guide for Testing Coating Powders and Powder Coatings) and ASTM D522/D522M—17 (Standard Test Methods for Mandrel Bend Test of Attached Organic Coatings).

Generally, smoother coatings, especially those coatings that are applied with powder coating processes, or rotational lining (‘rotolining’) processes are achievable with lower viscosity polymers. Also, to generalize, lower viscosity materials have a lower molecular weight, which in turn is associated with lower impact strength and reduced bending ductility. There is thus a need for fluoropolymer-based powder coating resins that result in smooth coatings, i.e., defined as having a surface roughness, Ra, measured according to ASME B46.1-2009 of 25 micro inches (μin) [0.64 microns (μm 10⁻⁶ m)] or less.

Surprisingly, it has been found that certain low viscosity fluoropolymers can produce extremely smooth powder coated surfaces, while retaining excellent impact strength and bending ductility. The preferred melt viscosity (according to ASTM D3825) of these materials as measured by capillary or parallel plate rheometry at 230° C. and a shear rate of 100 s⁻¹ ranges from 0.01 kP to 2.0 kP. Further, because of the lowered viscosity, it can be possible to use a lower bake temperature than would be possible with higher viscosity variants of the same material, because the lower viscosity materials flow better at the same temperature. Among the benefits of this lowered temperature is a decrease in yellowing of some materials, because higher temperatures are associated with this discoloration.

### SUMMARY OF THE INVENTION

The invention relates to a fluoropolymer comprising (in polymerized form) at least 60 weight percent of one or more fluoromonomers, wherein said fluoropolymer has a melt viscosity of 0.01 to below 2.0 kP, at 100 s⁻¹ and 230° C., as measured by parallel plate rheology, and has a weight-average molecular weight of from 15,000 to 200,000 Dalton as measured by GPC.

The invention also relates to the powdered resin formed from this fluoropolymer which is suitable to be used for powder coating or rotolining. These powdered fluoropolymer resins can be synthesized in a stable aqueous emulsion and then spray-dried, which produces particles in the range of 5 to 100 μm, depending on the processing parameters that are used, especially in the spray-drying step. The fluoropolymer particles can also be synthesized via suspension polymerization where 5 to 200 μm diameter particles can be generated during the synthesis. Size control of the particle is achieved by the material recipe, such as the stabilizer and initiator chemistries as well as the reaction parameters, such as agitation rate and design and reaction temperature as is known in the art. Additionally, monolithic materials, such as pellets with sizes in the 1-20 mm range are often ground at ambient or cryogenic temperatures to form a powder having polydispersed particle diameters. These polydispersed powders are then sieved to separate various diameter particles and thereby produce powder having narrower distributions of diameters, as is known in the art.

The invention further relates to a powder coating process and a rotolining process using these powdered fluoropolymers. The powder coating can be applied to either bare or primed substrates. Non-limiting examples of suitable substrates include metals such as aluminum or steel, glass or ceramics, wood and other cellulosics such as wood/plastic composites and wood laminates, as well as plastic substrates such as poly vinyl chloride (PVC), polystyrene or polyacrylates. It is also envisioned that the material of the current invention could be applied as part of a multi-layer construction either as a top-coat, mid-coat, or bottom coat, or lining (if the process is rotolining) as desired. The use of this low viscosity fluoropolymer as a powder coating results in surfaces exhibiting excellent smoothness while retaining good impact resistance and bending ductility.

The invention further relates to coatings or linings formed from the low melt viscosity fluoropolymer, using powder coating or rotolining processes. The use of the polymers of the present inventions facilitates the production of ultra-smooth coatings or linings that can be produced on either bare or primed substrates.

### DETAILED DESCRIPTION OF THE INVENTION

The invention relates to very low viscosity/high melt flow rate fluoropolymers having melt viscosity of 0.01 kP to below 2.0 kP, at 100 s⁻¹ and 230° C., as measured by parallel plate rheology, or capillary rheometry according to ASTM D1238-13. These fluoropolymers are in the form of powders that are useful in forming very smooth powder coatings or linings that retain good impact strength and bending ductility. These very low viscosity fluoropolymer powders are used for the processes of powder coating and rotolining.

Processing conditions are important and are usually optimized with directed empiricism to give the desired coating finish by changing heating temperatures and times. For example, too high of a temperature may cause the coating material to flow too much, giving non-uniformity (thin/thick spots); likewise, too low of a temperature could cause incomplete melting and flow, giving pinholes.

All references cited herein are incorporated by reference in their entirety for all purposes.

Unless otherwise indicated, all percentages herein are weight percentages, and all molecular weights are weight average molecular weights (M_{w}) measured by gel permeation chromatography (GPC).

“Polymer” as used herein, is meant to include organic molecules with a weight average molecular weight higher than 15,000 g/mol as measured by gel permeation chromatography.

Unless otherwise stated, all molecular weights are weight average molecular weights as determined by Gel Permeation Chromatography (GPC) in dimethylformamide (DMF)/0.003M LiBr solvent at room temperature, vs. poly(methyl methacrylate) narrow standard calibration, and all percentages are percentage by weight. Melt viscosities are determined by capillary rheometry according to ASTM D1238-13 or parallel plate rheometry at 230° C., and values reported are those taken at a shear rate of 100 s⁻¹.

The term “copolymer” as used herein indicates a polymer composed of two or more different monomer units, including two comonomers, three comonomers (terpolymers), and polymers having 4 or more different monomers. The copolymers may be random or block, may have a heterogeneous or homogeneous distribution of monomers, and may be synthesized by a batch, semi-batch or continuous process using neat monomer, solvent, aqueous suspension or aqueous emulsion as commonly known in the art.

The term “powder”, as used herein is understood to mean a composition comprising solid particles with sizes from 0.1 μm to 500 μm. Particles can be regularly-shaped (spheres) or irregularly-shaped such as those obtained by spray-drying an emulsion latex or grinding of larger pellets.

Surface roughness is measured according to ASME B46.1-2009 and is reported as μin (10⁻⁶ inches) and in μm (10-6 meters). ASME B46.1-2009, Section 2-3.2 Type II: Profiling Noncontact Instruments.

### Fluoropolymers

The low viscosity fluoropolymers used in this invention are homopolymers or copolymers containing fluorinated monomers in polymerized form. The presence of fluorine on the polymer is known to impart enhanced chemical resistance, thermal resistance, flame resistance, reduced coefficient of friction, high thermal stability, and enhancement of the material's triboelectricity. The term “fluoromonomer” or the expression “fluorinated monomer” means a polymerizable alkene which contains in its structure at least one fluorine atom, fluoroalkyl group, or fluoroalkoxy group whereby those groups are attached to the double bond of the alkene which undergoes polymerization. The term “fluoropolymer” means a polymer formed by the polymerization of at least one fluoromonomer, and it is inclusive of homopolymers and copolymers, branched, block, star, hyperbranched and other chain morphologies thereof. Thermoplastic polymers are capable of being formed into useful pieces by flowing upon the application of heat, such as is done in molding and extrusion processes, as well as the process of powder coating, wherein the surface to be coated is first optionally prepared by roughening the surface or applying a primer material. The surface (whether prepared or not) is then covered in a layer of powder and finally subjected to a heating, or baking step, that causes the powder particles to melt or soften and coalesce into a layer of polymer. This coating layer can then be optionally subjected to a further processing step, such as flame spray for touch-up or application of another layer. The process of rotolining similarly comprises melting a powder coating such that the particles coalesce into a polymer layer on the interior of the article to be lined. A typical rotolining process comprises a first optional step of preparing the interior surface to be coating, for instance by shotblasting or applying a primer. The interior of the article (for instance a container or length of pipe) is then charged with a suitable amount of the powdered polymer. The article is then heated in an oven while being rotated about two axes. The rotation rate and speed are accurately controlled and adjusted to suit the geometry of the item and the requirements of the particular polymer, particularly with regards to the temperature. The temperature during the lining process therefore is accurately monitored and controlled. When the required temperature profile of the article has been achieved the fabrication is gradually cooled and the lining is stabilized in such a way as to minimize stresses in the lining.

The fluoropolymers may be synthesized by any known means, including but not limited to bulk, solution, suspension, emulsion and inverse emulsion processes. Free-radical polymerization, as known in the art, is generally used for the polymerization of the fluoromonomers. The fluoropolymer can be synthesized in stable aqueous emulsion to produce primary particle diameters in the range of 150 nm-350 nm. This latex is then spray-dried with heated air causing agglomeration of the primary particles into larger agglomerates with sizes of 5 μm to 100 μm depending on the spray-drying process parameters, including but not limited to spray nozzle design, drying temperature, material feed rate, air flow design and volumetric air flow. In other cases, it is envisioned that the fluoropolymer could be synthesized via suspension polymerization where 5 μm to 200 μm diameter particles are produced wherein size control is achieved by the material recipe (stabilizer and initiator chemistries) and reaction parameters (agitation rate and design, reaction temperature) as known in the art. Additionally, monolithic materials (e.g. pellets with sizes in the 1 mm 20 mm range) are often ground (at ambient or cryogenic temperatures) to a powder that comprises polydisperse particle diameters. These powders are then sieved to separate various diameter particles and produce populations with narrower distributions of particle diameters. For this case, it does not matter which synthetic route was used (emulsion or suspension) because the reaction product will have been processed (extruded) and then pelletized before being ground into a powder.

The particle size of the starting powder generally defines the final thickness of the coating with rough correlation of smaller diameter particles leading to slightly thinner coating thickness. Generally, a narrow size distribution is preferred for better flowability of the particles and better control of the final coating thickness. However, it is envisioned that there may be cases where a non-uniform particle size distribution could give desirable final properties such as the presence of small particles to fill in micro-voids where a larger particle may not cover.

Fluoromonomers useful in the practice of the invention include, for example, vinylidene fluoride (VDF), tetrafluoroethylene (TFE), trifluoroethylene (TrFE), chlorotrifluoroethylene (CTFE), dichlorodifluoroethylene, hexafluoropropene (HFP), vinyl fluoride (VF), hexafluoroisobutylene (HFIB), perfluorobutylethylene (PFBE), 1,2,3,3,3-pentafluoropropene, 3,3,3-trifluoro-1-propene, 2-trifluoromethyl-3,3,3-trifluoropropene, 2,3,3,3-tetrafluoropropene, 1-chloro-3,3,3-trifluoropropene, fluorinated vinyl ethers including perfluoromethyl ether (PMVE), perfluoroethylvinyl ether (PEVE), perfluoropropylvinyl ether (PPVE), perfluorobutylvinyl ether (PBVE), longer chain perfluorinated vinyl ethers, fluorinated dioxoles, partially- or per-fluorinated alpha olefins of C4 and higher, partially- or per-fluorinated cyclic alkenes of C3 and higher, and combinations thereof. Fluoropolymers useful in the practice of the present invention include the products of polymerization of the fluoromonomers listed above, for example, the homopolymer made by polymerizing vinylidene fluoride (VDF) by itself or the copolymer of VDF and HFP.

In one embodiment of the invention, it is preferred that all monomer units be fluoromonomers, however, copolymers of fluoromonomers with non-fluoromonomers are also contemplated by the invention. In the case of a copolymer containing non-fluoromonomers, at least 60 percent by weight of the monomer units are fluoromonomers, preferably at least 70 weight percent, more preferably at least 80 weight percent, and most preferably at least 90 weight percent are fluoromonomers. Useful comonomers include, but are not limited to, ethylene, propylene, styrenics, acrylates, methacrylates, (meth)acrylic acid and salts therefrom, alpha-olefins of C4 to C16, butadiene, isoprene, vinyl esters, vinyl ethers, non-fluorine-containing halogenated ethylenes, vinyl pyridines, and N-vinyl linear and cyclic amides.

In one embodiment, the fluoropolymer does not contain ethylene monomer units.

In a preferred embodiment, the fluoropolymer contains a majority by weight of vinylidene fluoride (VDF) monomer units, preferably at least 70 weight percent VDF monomer units, and more preferably at least 80 weight percent of VDF monomer units.

Other useful fluoropolymers include, but are not limited to polyvinyl fluoride (PVF), polychlorotrifluoroethylene (CTFE), polytetrafluoroethylene (PTFE), fluorinated ethylene vinyl ether (FEVE), and (per)fluorinated ethylene-propylene (FEP).

As discussed above, fluoropolymers and copolymers may be obtained using known methods of solution, emulsion, and suspension polymerization. In a preferred embodiment, the fluoropolymer is synthesized using emulsion polymerization whereby the emulsifying agent (‘surfactant’) is either perfluorinated, fluorinated, or non-fluorinated. In one embodiment, a fluorocopolymer is formed using a fluorosurfactant-free emulsion process. Examples of non-fluorinated (fluorosurfactant-free) surfactants are described in U.S. Pat. Nos. 8,080,621, 8,124,699, 8,158,734, and 8,338,518 all herein incorporated by reference for all purposes. In the case of emulsion polymerization utilizing a fluorinated or perfluorinated surfactant, some specific, but not limiting examples are the salts of the acids described in U.S. Pat. No. 2,559,752 of the formula X(CF₂)ₙ COOM, wherein X is hydrogen or fluorine, M is an alkali metal, ammonium, substituted ammonium (e.g., alkylamine of 1 to 4 carbon atoms), or quaternary ammonium ion, and n is an integer from 6 to 20; sulfuric acid esters of polyfluoroalkanols of the formula X(CF₂)ₙ—CH₂—OSO₃M, where X, n and M are as above; and salts of the acids of the formula CF₃ (CF₂)ₙ—(CX₂)ₘ—SO₃M, where X and M are as above, n is an integer from 3 to 7, and m is an integer from 0 to 2, such as in potassium perfluorooctyl sulfonate. The use of a microemulsion of perfluorinated polyether carboxylate in combination with neutral perfluoropolyether in vinylidene fluoride polymerization can be found in EP0816397A1. The surfactant charge is from 0.05% to 2% by weight on the total monomer weight used, and most preferably the surfactant charge is from 0.1% to 0.2% by weight.

The fluoropolymers useful in the invention are low molecular weight and have a melt viscosity of 0.01 to 2.0 kP, preferably from 0.03 to 1.0 kP, preferably from 0.05 to 1.0 kP, and more preferably from 0.1 to 0.8 kP at 100 s⁻¹ and 230° C., as measured by parallel plate rheology. Alternately, the viscosity could be measured using capillary rheometry under the same conditions, according to ASTM D3825. The two methods were found to produce similar results. The weight average molecular weight of the fluoropolymer is from 15,000 to 200,000 Dalton, preferably from 15,000 to 100,000 Dalton, as measured by GPC in DMF/0.003M LiBr at room temperature, vs. poly(methyl methacrylate) narrow standard calibration. The materials exhibit a polydispersity, as defined by the weight average molecular weight divided by the number average molecular weight in the range of 1.5 to 3.0, typical of products of free-radical polymerization processes. Polydispersity can be modified by techniques known in the art such as but not limited to controlled polymerization, blending and modification of feed schedules of initiator and chain-transfer agent(s). For example, it may be advantageous for a material to exhibit a very broad polydispersity as high MW materials can impart improved mechanical properties, while a plurality of low MW chains gives improved melt processability.

Low molecular weight fluoropolymers of the invention can be obtained by using one or more chain transfer agent at high levels as compared to reaction processes used to generate high molecular weight engineering thermoplastics. Useful chain transfer agents include, but are not limited to C2 to C18 hydrocarbons like ethane, propane, n-butane, isobutane, pentane, isopentane, 2,2-dimethylpropane, and longer alkanes and isomers thereof. Also useful are alkyl and aryl esters such as pentaerythritol tetraacetate, methyl acetate, ethyl acetate, propyl acetate, iso-propyl acetate, ethyl propionate, ethyl isobutyrate, ethyl tert-butyrate, diethyl maleate, ethyl glycolate, benzyl acetate, C1-C16 alkyl benzoates, and C3-C18 cycloalkyl alkyl esters such as cyclohexyl acetate. Alcohols, carbonates, ketones, halocarbons, hydrohalocarbons, such as chlorocarbons, hydrochlorocarbons, chlorofluorocarbons, hydrochlorofluorocarbons, chlorosilanes and alkyl and aryl sulfonyl chlorides are also contemplated useful chain transfer agents. In one preferred embodiment a hydrocarbon or ester are used. The amount of chain-transfer agent can be from 0.01 to 30.0% of the total monomer incorporated into the reaction, preferably from 0.1 to 20.0% and most preferably from 0.2 to 10.0%. Chain-transfer agents may be added all at once at the beginning of the reaction, in portions throughout the reaction, or continuously as the reaction progresses or in combinations of these methods. The amount of chain-transfer agent and mode of addition which is used depends on the activity of the agent and the desired molecular weight characteristics of the product.

It is also envisioned that the polymerization could occur in a solvent system where the solvent acts as the chain transfer agent, or a solvent system with a functionally-inert solvent and an additional chain-transfer-active compound. Performing the reaction at higher temperatures would also be expected to produce lower molecular weight polymer, as would increasing the level of initiator.

The reaction can be started and maintained by the addition of any suitable initiator known for the polymerization of fluorinated monomers including inorganic peroxides, ‘redox’ combinations of oxidizing and reducing agents, and organic peroxides. Examples of typical inorganic peroxides are the ammonium or alkali metal salts of persulfates, which have useful activity in the 65° C. to 105° C. temperature range. “Redox” systems can operate at even lower temperatures and examples include combinations of oxidants such as hydrogen peroxide, t-butyl hydroperoxide, cumene hydroperoxide, or persulfate, and reductants such as reduced metal salts, iron (II) salts being a particular example, optionally combined with activators such as sodium formaldehyde sulfoxylate or ascorbic acid. Among the organic peroxides which can be used for the polymerization are the classes of dialkyl peroxides, peroxyesters, and peroxydicarbonates. Exemplary of dialkyl peroxides is di-t-butyl peroxide, of peroxyesters are t-butyl peroxypivalate and t-amyl peroxypivalate, and of peroxydicarbonates are di(n-propyl) peroxydicarbonate, diisopropyl peroxydicarbonate, di(secbutyl)peroxydicarbonate, and di(2-ethylhexyl) peroxydicarbonate. The use of diisopropyl peroxydicarbonate for vinylidene fluoride polymerization and copolymerization with other fluorinated monomers is taught in U.S. Pat. No. 3,475,396, and its use in making vinylidene fluoride/hexafluoropropylene copolymers is further illustrated in U.S. Pat. No. 4,360,652. The use of di(n-propyl) peroxydicarbonate in vinylidene fluoride polymerizations is described in Japanese Published Unexamined Application (Kokai) JP 58065711. The quantity of an initiator required for a polymerization is related to its activity and the temperature used for the polymerization. The total amount of initiator used is generally between 0.05% to 2.5% by weight based on the total monomer weight used. Typically, sufficient initiator is added at the beginning to start the reaction and then additional initiator may be optionally added to maintain the polymerization at a convenient rate. The initiator may be added in pure form, in solution, in suspension, or in emulsion, depending upon the initiator chosen. As a particular example, peroxydicarbonates are conveniently added in the form of an aqueous emulsion.

In one embodiment a branched or star polymer is produced, using a long-chain comonomer, multi-functional (co)monomer, multi-functional chain-transfer agent, multi-functional initiator or by adjusting process conditions to increase the rate of chain-transfer to polymer, thus providing active sites for branches to grow from the polymer backbone. Branching could induce melt shear thinning of the polymer, decreasing the viscosity at higher shear rates and thus increasing the melt flow rate, particularly under high-shear conditions.

The fluoropolymer composition of the invention, capable of being melt-processed or used in a powder coating operation or a rotolining operation, contains one or more fluoropolymers, and optionally one or more additives including but not limited to plasticizers; inorganic fillers such as talc, calcium carbonate, inorganic fibers, including glass fibers, carbon fibers and carbon nanotubes; pigments; dyes; antioxidants; impact modifiers; surfactants; dispersing aids; compatible or incompatible non-fluoropolymers; and solvents as known in the art. Additives are generally used in the fluoropolymer composition at levels up to 40 weight percent based on the fluoropolymer, more preferably at a level of 0.001 to 30 weight percent, and more preferably from 0.001 to 20 weight percent. The additives can be introduced to the fluoropolymer composition by known means prior to the powder coating operation. Non-limiting examples of such blending methods include dry blending of powders, or by melt blending the additive with the fluoropolymer prior to forming the powder that will be coated onto a substrate.

If desired, pigments or other colorants may be incorporated by dry blending with the powdered resin, or melt blended with the resin, extruded and then powdered. Any pigment (or other colorant) known to be useful in polyvinylidene fluoride based coatings may be employed. The pigments may include, for example, those pigments identified in U.S. Pat. No. 3,340,222. The pigment (or other colorant) may be organic or inorganic. According to one embodiment, the pigment may comprise titanium dioxide, or titanium dioxide in combination with one or more other inorganic pigments wherein titanium dioxide comprises the major part of the combination. Inorganic pigments which may be used alone or in combination with titanium dioxide include, for example, silica, iron oxides of various colors, cadmium, lead titanate, and various silicates, for example, talc, diatomaceous earth, asbestos, mica, clay and basic lead silicate. Pigments which may be used in combination with titanium dioxides include, for example, zinc oxide, zinc sulfide, zirconium oxide, white lead, carbon black, lead chromate, leafing and non-leafing metallic pigments, molybdate orange, calcium carbonate and barium sulfate. The preferred pigment category is the ceramic metal oxide type pigments which are calcined. Chromium oxides and some iron oxides of the calcined type may also be satisfactorily utilized. For applications where a white coating is desired, a non-chalking, non-yellowing rutile-type of titanium dioxide is recommended. Lithopones and the like are inadequate as they suffer from lack of chalk resistance and/or from inadequate hiding. Anastase TiO₂ is similarly not recommended. The pigment (or other colorant) component, when present, is advantageously present in the composition in an amount of from about 0.1 to about 50 parts by weight per 100 parts of resin component. For most applications the preferred range is from about 5 to about 20 parts by weight pigment per 100 parts of resin component. Clear metallic pigmented coats will have very low amounts by weight of pigment.

The fluoropolymers can be blended with other polymers, using methods as are known in the art. Blending with poly(meth)acrylates (PMMA) is well known in the art to improve the flow properties of the melt, although advantageously, the fluoropolymer described herein does not require a PMMA additive to improve flowability. In certain instances, the lack of PMMA can improve the weatherability of the final coating.

Dry blends with powdered polymers are within the scope of the invention as well as blends that are created by compounding polymers together in the melt, pelletizing and then grinding the resulting pellets according to methods that are known in the art. Non-limiting examples of suitable polymers to blend include polyamides, engineering polymers such as polyaryletherketones (e.g., PEEK, PEKK), other fluoropolymers, polyacrylates, poly(meth)acrylates, polystyrenics, polyolefins, polyvinyl chloride, polyurethanes or polyesters. Copolymers of any of these polymers may also be used. These blends may be melt-miscible with the fluoropolymers, such as in the case of PVDF blended with polymethacrylates. Alternatively, the blended polymer may be immiscible with the fluoropolymers, as would be expected to be the case for most of the above-named blends.

### Processing and Manufacturing Methods of Powder Coating and Rotolining

The primary uses of the low viscosity fluoropolymer materials are for powder coating and rotational lining (‘rotolining’), since these materials are advantageously used as a thin layer of material applied to an existing part.

Methods of producing powder coatings using the low viscosity fluoropolymers may be any of such methods as are known in the industry. Non-limiting examples include: fluid bed dipping, fluid bed dipping w/ charge, electrostatic spraying, hot spraying without charge, hot spraying with charge, flame spraying, plasma spraying, minicoating, maxicoating, electromagnetic brushing, or solvent cast/powder slurry techniques.

Impact resistance and bending ductility are related to the composition of the coating material. The composition of the coating material is defined as the comonomers in the ‘base’ material. The average molecular weight of the plurality of polymer chains in the ‘base’ material also has an effect on these properties. The nature and amount of additives also affects impact resistance and bending ductility.

Likewise, methods of rotolining parts such as metal vessels, tanks, pipes, pump components, valve fittings, various containers, vessels, filter housings, high purity linings for semiconductor applications or other components for corrosion protection and chemical resistance are known in the art.

Process parameters such as heat distribution and bake time of the lining or coating can be empirically determined, and are affected by the engineering of the oven or other heating apparatus and are not necessarily material dependent. Bake temperature is estimated using the bulk melting point of the material and its bulk rheological properties. A temperature at least 30° C. above the melting point of the material is typical. For a high-flowing, low viscosity material, such as those described herein, it is can be possible to use a lower bake temperature than would be necessary with higher viscosity variants of the same material. These lower temperatures can reduce the possibility of yellowing of the final coating or lining.

The powder coating may be applied to the substrate by any known conventional application method which will provide a uniform coating. Typical, non-limiting techniques for applying the polymer powder for the process of powder coating are fluidized bed, thermal spray, or preferably electrostatic coating. A target coating thickness is typically 50 microns (˜2 mils). For example, the powder may be ground and classified to an average particle diameter of about 40 to 60 microns. This average particle diameter range will be adjusted upward or downward for thicker or thinner desired coatings, respectively. The powder coating may be applied over the substrate with or without a primer coating. After application of the powder, the coating is subjected to heat treatment which is sufficient to melt a portion of the powder. Therefore, the temperature must be above the melt temperature of the coating formulation. The melt temperature is typically between 140° C. and 260° C. for PVDF homopolymer. However, lower temperatures can be used if the melting point of the coating material is lower, such as certain materials of the present invention where the melting point is approximately 123° C. For such a material, a heating temperature between 150° C. and 230° C. would be appropriate, although higher temperatures are also applicable to further increase flowability, which is to say, decrease melt viscosity, or increase throughput on a continuous production process. The coating and the substrate are then cooled by suitable means.

Due to the high bake temperatures, the coatings are primarily useful as coatings on metal substrates and similar thermally stable substrates, such as metal (e.g., aluminum, steel), glass, ceramics and cellulosics. These substrates may be treated or modified to improve the adhesion of the powder coating according to methods known in the art. The applications of such coated substrates are those where the chemical and radiation resistance of fluoropolymers are required, in addition to a need for very smooth surfaces, together with good impact resistance and bending ductility. Nuclear glove boxes are an example of such an application, because the smooth surface allows for easy decontamination, and good impact resistance and bending ductility enhance durability while radiation resistance is critical.

Other applications requiring long term UV resistance, high smoothness and good impact resistance along with good bending ductility are envisaged. Typical examples are metal building parts (window frames, door frames roofing, wall panels, furniture components and the like) and automotive components. Use as functional coatings (for corrosion and/or wear resistance, for example) is also contemplated. Typical applications that use the rotolining process are also envisaged.

### Primers

The metal or substrate to be coated can optionally be coated with a primer prior to the powder coating operation. Non-limiting examples of typical primers include epoxies, polyurethanes, fluoropolymers such as Kynar® ADX (Arkema), or fluoropolymer blends such as those described in EP 0404752 A1. These primers are applied according to methods known to those of skill in the art, including air spraying, flame spraying, dipping, or brush coating, slot-die or gravure application, followed by curing and/or drying as appropriate for the particular primer chemistry.

Physical or mechanical preparation and/or cleaning and/or pretreatment of the substrate to be coated is also envisaged. Non-limiting examples of such methods are shot (or other media) blasting, chemical etching, phosphating, physical sanding or grinding, chemical or metal deposition such as anodizing, or others. Other non-limiting examples of mechanical cleaning include but are not limited abrasive cleaning, sand blasting, scratch brushing or mechanical scuffing. It is to be understood that such treatments are optional, particularly pre-treatment comprising these mechanical cleaning methods.

### Coating Thickness

The fluoropolymer-based powder coated or rotolined layer is preferably from 0.1 mil (2.0 μm) to more than 300 mil (7600 μm) thick, preferably from 2.0 mil (50 μm) to 250 mil (6500 μm) thick, and more preferably from 5.0 mil (125 μm) to 200 mil (5000 μm) thick.

It is understood that the thickness of each powder coated layer or a lining applied by rotolining depends at least in part on the average particle diameter of the powder used to form the coating or lining. Suitable average particle diameters as measured according to light scattering as exemplified in ASTM B822-17 (“Standard Test Method for Particle Size Distribution of Metal Powders and Related Compounds by Light Scattering”) or can be classified by physical sieving and can range from 0.4 to 200 μm. Additionally, multiple layers of the same material as the invention, or different materials from the invention may be deposited to build up to a final desired thickness.

### Substrates

Suitable substrates that can be coated with the fluoropolymer-based powder coating include but are not limited to metal, glass, ceramic, wood and other cellulosics such as wood/plastic composites and wood laminates, and plastic substrates such as poly(vinyl chloride) (PVC), polystyrene, and polyacrylates that can withstand the temperatures needed melt the powder coating.

### Material Properties

Roughness is reported as Ra in units of μin (10⁻⁶ inch) and μm (micron or 10⁻⁶ meter), which is the arithmetic average of the absolute values of the profile height deviations from the mean line, recorded within the evaluation length measured according to ASME B46.1-2009. Coating uniformity is evaluated visually for thin spots (fish-eyes), pinholes, bubbles or irregularity (orange-peel).

As discussed above, viscosity is reported as kilopoise (kP), measured using a parallel plate rheometer at 230° C. and a shear rate of 100 s⁻¹, or a capillary rheometer at 230° C. and a shear rate of 100 s⁻¹, according to ASTM D 1238-13.

Coating thickness is measured by profilometry or cross-sectional optical microscopy or ultrasonic gauge, such as in ASTM D6132-13(2017): Standard Test Method for Non-Destructive Measurement of Dry Film Thickness of Applied Organic Coatings Using an Ultrasonic Coating Thickness Gauge.

Adhesion is measured according to ASTM D4541-17: Standard Test Method for Pull-Off Strength of Coatings Using Portable Adhesion Testers and reported in pounds-force per square inch (psi) and megapascals (MPa). The self-aligning adhesion tester type VI (Test Method F) was used.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Various non-limiting aspects of the invention may be summarized as follows:

Aspect 1: A fluoropolymer composition for manufacturing a coating on at least one surface of a substrate wherein the fluoropolymer composition comprises a fluoropolymer having at least 60 weight percent of one or more fluoromonomers, wherein the fluoropolymer is in the form of a powder, has a melt viscosity of 0.01 to 2.0 kP, at 100 s⁻¹ and 230° C., as measured by parallel plate rheology, and has a weight average molecular weight of from 15,000 to 200,000 Dalton as measured by GPC relative to poly(methyl methacrylate) (PMMA) narrow standards and wherein the coating on the at least one surface of the substrate has a surface roughness Ra measured according to ASME B46.1-2009 of 0.64 microns (μm) or less.

Aspect 2: The fluoropolymer composition according to Aspect 1 wherein the fluoropolymer has a melt viscosity of 0.02 to 1.0 kP, at 100 s⁻¹ and 230° C., as measured by parallel plate rheology, and has a weight average molecular weight of from 15,000 to 140,000 Dalton as measured by GPC relative to PMMA narrow standards.

Aspect 3: The fluoropolymer composition according to Aspect 1, wherein the fluoropolymer has a melt viscosity of 0.03 to 0.8 kP, at 100 s⁻¹ and 230° C., as measured by parallel plate rheology, and has a weight average molecular weight of from 15,000 to 100,000 Dalton as measured by GPC relative to PMMA narrow standards.

Aspect 4: The fluoropolymer composition according to any of Aspects 1-3, wherein the fluoropolymer is comprised of, in polymerized form, one or more fluoromonomers selected from the group consisting of vinylidene fluoride (VDF), tetrafluoroethylene (TFE), trifluoroethylene (TrFE), chlorotrifluoroethylene (CTFE), dichlorodifluoroethylene, hexafluoropropene (HFP), vinyl fluoride (VF), hexafluoroisobutylene (HFIB), perfluorobutylethylene (PFBE), pentafluoropropene, 3,3,3-trifluoro-1-propene, 2-trifluoromethyl-3,3,3-trifluoropropene, fluorinated vinyl ethers including perfluoromethyl ether (PMVE), perfluoroethylvinyl ether (PEVE), perfluoropropylvinyl ether (PPVE), perfluorobutylvinyl ether (PBVE), longer chain perfluorinated vinyl ethers, fluorinated dioxoles, partially- or per-fluorinated alpha olefins of C4 and higher, partially- or per-fluorinated cyclic alkenes of C3 and higher, and combinations thereof.

Aspect 5: The fluoropolymer composition according to any of Aspects 1-4, wherein the fluoropolymer comprises either a homopolymer of vinylidene fluoride or a copolymer having at least 51 weight percent of vinylidene fluoride monomer units.

Aspect 6: The fluoropolymer composition according to any of Aspects 1-4, wherein the fluoropolymer comprises from 65 to 99 weight percent of vinylidene fluoride monomer units and from 1 to 35 weight percent of hexafluoropropene monomer units.

Aspect 7: The fluoropolymer composition according to any of Aspects 1-6, further comprising one or more additives selected from the group consisting of plasticizers, inorganic fillers, colorants, dyes, antioxidants, compatible non-fluoropolymers, (meth)acrylate homopolymers and copolymers, and solvents.

Aspect 8: The fluoropolymer composition according to any of Aspects 1-7, wherein the powdered fluoropolymer has an average particle size of 5 to 100 microns (μm) as measured by light scattering or microscopy.

Aspect 9: A method of providing a fluoropolymer composition coating on at least one surface of a substrate, wherein the fluoropolymer composition comprises the fluoropolymer composition according to any of Aspects 1-8 and the method of providing the fluoropolymer composition coating is powder coating.

Aspect 10: A method of providing a fluoropolymer composition coating on at least one surface of a substrate, wherein the fluoropolymer composition comprises the fluoropolymer composition according to any of Aspects 1-8 and the method of providing the fluoropolymer composition coating is rotolining.

Aspect 11: An article of manufacture comprising a substrate having a coating on at least one surface, wherein the coating comprises the fluoropolymer composition according to any of Aspects 1-8.

Aspect 12: An article of manufacture made according to the method of Aspect 9.

Aspect 13: An article of manufacture made according to the method of Aspect 9 wherein the coated substrate comprises at least one of metal, ceramic, glass, wood, wood composite, wood laminate, plastic, plastic fiber composite, or plastic inorganic composite.

Aspect 14: An article of manufacture made according to the method of Aspect 10.

Aspect 15: An article of manufacture made according to the method of Aspect 10 wherein the coated substrate comprises metal, ceramic, glass, wood, wood composite, wood laminate, plastic, plastic fiber composite, or plastic inorganic composite.

Aspect 16: A fluoropolymer composition for manufacturing an article, wherein the article has a surface to be coated with the fluoropolymer composition and wherein the fluoropolymer composition comprises a fluoropolymer having at least 60 weight percent of one or more fluoromonomers, wherein the fluoropolymer is in the form of a powder, has a melt viscosity of 0.01 to 2.0 kP, at 100 s-1 and 230° C., as measured by parallel plate rheology, wherein the fluoropolymer coating on the surface has a surface roughness Ra measured according to ASME B46.1-2009 of 0.64 microns (μm) or less.

Aspect 17: The fluoropolymer composition for manufacturing an article according to Aspect 16 wherein the fluoropolymer coating has a surface roughness Ra measured according to ASME B46.1-2009 of 0.3 microns (μm) or less.

Aspect 18: The fluoropolymer composition for manufacturing an article according to Aspect 16 wherein the fluoropolymer coating has a surface roughness Ra measured according to ASME B46.1-2009 of 0.25 microns (μm) or less.

Aspect 19: The fluoropolymer composition for manufacturing an article according to any of Aspects 16-18 wherein the surface to be coated has not been treated with primer.

Aspect 20: The fluoropolymer composition for manufacturing an article according to any of Aspects 16-18 wherein the surface to be coated has been treated with primer.

Aspect 21: The fluoropolymer composition for manufacturing an article according to any of Aspects 16-18 wherein the fluoropolymer composition is applied to the surface in multiple layers.

Aspect 22: A coated article made according to the method of Aspect 9 wherein the adhesive strength of the coating is 5.2 MPa or greater as measured by method ASTM D4541-17.

Aspect 23: A coated article made according to the method of Aspect 9 wherein the adhesive strength of the coating is 5.2 MPa or greater as measured by method ASTM D4541-17 and a primer is not used on the substrate.

Aspect 24: A coated article made according to the method of Aspect 9 wherein the adhesive strength of the coating is 5.2 MPa or greater as measured by method ASTM D4541-17 and a primer is not used on the substrate, and the substrate is not pre-treated by any mechanical cleaning method.

Aspect 25: A coated article made according to the method of Aspect 10 wherein the adhesive strength of the coating is 5.2 MPa or greater as measured by method ASTM D4541-17.

Aspect 26: A coated article made according to the method of Aspect 10 wherein the adhesive strength of the coating is 5.2 MPa or greater as measured by method ASTM D4541-17 and a primer is not used on the substrate.

Aspect 27: A coated article made according to the method of Aspect 10 wherein the adhesive strength of the coating is 5.2 MPa or greater as measured by method ASTM D4541-17 and a primer is not used on the substrate, and the substrate is not pre-treated by any mechanical cleaning method.

### EXAMPLES

### Example 1: Coating Roughness

Four powder coated samples were prepared as follows: The substrates were preheated to 260° C. A primer was then applied electrostatically using a powder coating gun to a thickness of 75-125 microns (3-5 mils) to three of the samples. Two of these samples having the primer coating and a third sample with no primer were then placed back into the oven at about 204° C. When sufficiently heated, they were removed from the oven and the inventive low-viscosity PVDF powder was applied in a similar fashion as the primer. This coating process was repeated several times with additional inventive low-viscosity PVDF powder until the desired coating thickness was achieved. The samples were cooled and the roughness, Ra, was measured according to ASME B46.1-2009.

The results are shown in Table 1, along with the reported roughness values.

TABLE 1
Roughness Testing Results

| | | | Ra | Ra |
|---|---|---|---|---|
| | Primer | Coating | μin | μm |
| Compar- | 90% KynarFlex ® 2850PC* | — | >25 | >0.64 |
| ative | 10% Kynar SuperFlex ® | | | |
| | 2500-00* | | | |
| KS1 | 90% KynarFlex ® 2850PC* | Low | 15.2 | 0.30 |
| Inventive | 10% Kynar SuperFlex ® | viscosity | 16.1 | 0.41 |
| | 2500-00* | fluoropolymer | 17.5 | 0.45 |
| KS2 | — | Low | 22.1 | 0.56 |
| Inventive | | viscosity | 10.7 | 0.27 |
| | | fluoropolymer | 15.0 | 0.38 |
| KS3 | Standard primer** | Low | 11.9 | 0.30 |
| Inventive | | viscosity | 13.6 | 0.35 |
| | | fluoropolymer | 15.1 | 0.38 |

*fluoropolymer (Arkema)
**thermosetting and thermoplastic resin blend

### Example 2: Adhesion of Coating to Substrate

A four-position, stainless steel DeFelsko adhesion testing plate was cleaned with isopropanol-soaked wipe on the coupon areas before use. The coupons were then preheated to 260° C. and a standard primer blend of thermosetting and thermoplastic resin was electrostatically applied to one of the coupons using a powder coating gun to a thickness of 75-125 microns (3-5 mils). All of the coupons (with and without primer) were placed back into the oven at about 204° C. The heated coupons were removed and the appropriate powder (either low-viscosity inventive PVDF or a standard PVDF) were applied over the primer, using the same procedure as was used to apply the primer. The coating process was repeated several times with additional PVDF powder until the desired thickness was achieved.

The roughness of the coating was measured according to ASME B46.1-2009.

For adhesion testing, strong adhesive was applied to the coating surfaces. Adhesion dollies were placed on respective test positions, per ASTM D4541-17 Standard Test Method for Pull-Off Strength of Coatings Using Portable Adhesion Testers. The results of the adhesion testing and the surface roughness of the samples are shown in Table 2.

TABLE 2
Roughness and Adhesion Results

| | Coating | Primer | Coating Roughness | | Adhesion | |
|---|---|---|---|---|---|---|
| Sample | Material | Used | Ra, μin | Ra, μm | psi | MPa |
| 1 | Kynar ® ADX | None | 20-25 | 5.0-6.25 | <100* | <0.69 |
| comparative | PVDF | | | | | |
| | (Arkema) | | | | | |
| 2 | Low viscosity | None | <10 | <2.5 | 1000 | 6.89 |
| invention | PVDF | | | | | |
| 3 | Low viscosity | Yes | <10 | <2.5 | 3000 | 20.68 |
| invention | PVDF | | | | | |

*Very low adhesion, nearly un-measurable with the method.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A fluoropolymer composition for manufacturing a coating on at least one surface of a substrate wherein the fluoropolymer composition comprises a fluoropolymer having at least 60 weight percent of one or more fluoromonomers, wherein the fluoropolymer is in the form of a powder, has a melt viscosity of 0.01 to 2.0 kP, at 100 s⁻¹ and 230° C., as measured by parallel plate rheology, and has a weight average molecular weight of from 15,000 to 200,000 Dalton as measured by GPC relative to poly(methyl methacrylate) (PMMA) narrow standards and wherein the coating on the at least one surface of the substrate has a surface roughness Ra measured according to ASME B46.1-2009 of 0.64 microns (μm) or less.

2. The fluoropolymer composition according to claim 1 wherein the fluoropolymer has a melt viscosity of 0.02 to 1.0 kP, at 100 s⁻¹ and 230° C., as measured by parallel plate rheology, and has a weight average molecular weight of from 15,000 to 140,000 Dalton as measured by GPC relative to PMMA narrow standards.

3. The fluoropolymer composition according to claim 1, wherein the fluoropolymer has a melt viscosity of 0.03 to 0.8 kP, at 100 s⁻¹ and 230° C., as measured by parallel plate rheology, and has a weight average molecular weight of from 15,000 to 100,000 Dalton as measured by GPC relative to PMMA narrow standards.

4. The fluoropolymer composition according to claim 1, wherein the fluoropolymer is comprised of, in polymerized form, one or more fluoromonomers selected from the group consisting of vinylidene fluoride (VDF), tetrafluoroethylene (TFE), trifluoroethylene (TrFE), chlorotrifluoroethylene (CTFE), dichlorodifluoroethylene, hexafluoropropene (HFP), vinyl fluoride (VF), hexafluoroisobutylene (HFIB), perfluorobutylethylene (PFBE), pentafluoropropene, 3,3,3-trifluoro-1-propene, 2-trifluoromethyl-3,3,3-trifluoropropene, fluorinated vinyl ethers including perfluoromethyl ether (PMVE), perfluoroethylvinyl ether (PEVE), perfluoropropylvinyl ether (PPVE), perfluorobutylvinyl ether (PBVE), longer chain perfluorinated vinyl ethers, fluorinated dioxoles, partially- or per-fluorinated alpha olefins of C4 and higher, partially- or per-fluorinated cyclic alkenes of C3 and higher, and combinations thereof.

5. The fluoropolymer composition according to claim 4, wherein the fluoropolymer comprises either a homopolymer of vinylidene fluoride or a copolymer having at least 51 weight percent of vinylidene fluoride monomer units.

6. The fluoropolymer composition according to claim 4, wherein the fluoropolymer comprises from 65 to 99 weight percent of vinylidene fluoride monomer units and from 1 to 35 weight percent of hexafluoropropene monomer units.

7. The fluoropolymer composition according to claim 1, further comprising one or more additives selected from the group consisting of plasticizers, inorganic fillers, colorants, dyes, antioxidants, compatible non-fluoropolymers, (meth)acrylate homopolymers and copolymers, and solvents.

8. The fluoropolymer composition according to claim 1, wherein the powdered fluoropolymer has an average particle size of 5 to 100 microns (μm) as measured by light scattering or microscopy.

9. A method of providing a fluoropolymer composition coating on at least one surface of a substrate, wherein the fluoropolymer composition comprises the fluoropolymer composition according to claim 1 and the method of providing the fluoropolymer composition coating is powder coating.

10. A method of providing a fluoropolymer composition coating on at least one surface of a substrate, wherein the fluoropolymer composition comprises the fluoropolymer composition according to claim 1 and the method of providing the fluoropolymer composition coating is rotolining.

11. An article of manufacture comprising a substrate having a coating on at least one surface, wherein the coating comprises the fluoropolymer composition according to claim 1.

12. An article of manufacture made according to the method of claim 9.

13. An article of manufacture made according to the method of claim 9 wherein the coated substrate comprises at least one of metal, ceramic, glass, wood, wood composite, wood laminate, plastic, plastic fiber composite, or plastic inorganic composite.

14. An article of manufacture made according to the method of claim 10.

15. An article of manufacture made according to the method of claim 10 wherein the coated substrate comprises at least one of metal, ceramic, glass, wood, wood composite, wood laminate, plastic, plastic fiber composite, or plastic inorganic composite.

16. A fluoropolymer composition for manufacturing an article, wherein the article has a surface to be coated with the fluoropolymer composition and wherein the fluoropolymer composition comprises a fluoropolymer having at least 60 weight percent of one or more fluoromonomers, wherein the fluoropolymer is in the form of a powder, has a melt viscosity of 0.01 to 2.0 kP, at 100 s⁻¹ and 230° C., as measured by parallel plate rheology, wherein the fluoropolymer coating on the surface has a surface roughness Ra measured according to ASME B46.1-2009 of 0.64 microns (μm) or less.

17. The fluoropolymer composition for manufacturing an article according to claim 16 wherein the fluoropolymer coating has a surface roughness Ra measured according to ASME B46.1-2009 of 0.3 microns (μm) or less.

18. The fluoropolymer composition for manufacturing an article according to claim 16 wherein the fluoropolymer coating has a surface roughness Ra measured according to ASME B46.1-2009 of less than 0.25 microns (μm).

19. The fluoropolymer composition for manufacturing an article according to claim 16 wherein the surface to be coated has not been treated with primer.

20. The fluoropolymer composition for manufacturing an article according to claim 16 wherein the surface to be coated has been treated with primer.

21. The fluoropolymer composition for manufacturing an article according to claim 16 wherein the fluoropolymer composition is applied to the surface in multiple layers.

22. A coated article made according to the method of claim 9 wherein the adhesive strength of the coating is 5.2 MPa or greater as measured by method ASTM D4541-17.

23. A coated article made according to the method of claim 9 wherein the adhesive strength of the coating is 5.2 MPa or greater as measured by method ASTM D4541-17 and a primer is not used on the substrate.

24. A coated article made according to the methods of claim 9 wherein the adhesive strength of the coating is 5.2 MPa or greater as measured by method ASTM D4541-17 and a primer is not used on the substrate, and the substrate is not pre-treated by any mechanical cleaning method.

25. A coated article made according to the method of claim 10 wherein the adhesive strength of the coating is 5.2 MPa or greater as measured by method ASTM D4541-17.

26. A coated article made according to the method of claim 10 wherein the adhesive strength of the coating is 5.2 MPa or greater as measured by method ASTM D4541-17 and a primer is not used on the substrate.

27. A coated article made according to the method of claim 10 wherein the adhesive strength of the coating is 5.2 MPa or greater as measured by method ASTM D4541-17 and a primer is not used on the substrate, and the substrate is not pre-treated by any mechanical cleaning method.
